(19) United States
(12) Patent Application Publication
(10) Pub. No.: US 2006/0244353 A1
(43) Pub. Date: Nov. 2, 2006

(54) Electric lamp an dlamp base

(76) Inventor: Renatus Hendricus Maria Sanders, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/553,558

(22) PCT Filed: Apr. 22, 2004
(86) PCT No.: PCT/IB04/50483

§ 371 Date: Oct. 19, 2005

(30) Foreign Application Priority Data
Apr. 23, 2003 (EP) 03101111.7

(51) Int. Cl. H01J 5/48

(52) U.S. Cl. 313/318.01

(57) ABSTRACT

An electric lamp has a lamp vessel (1) and is provided with an illumination source (2). A central current-supply conductor (3) and a side current-supply conductor (4) issue from the lamp vessel. The electric lamp has a lamp base (5) for providing a mechanical connection of the lamp vessel and for providing a mechanical and electrical connection of the current-supply conductors. At a side facing the lamp vessel, the lamp base is provided with a notch (6) for passing through the side current-supply conductor. At a side facing away from the lamp base, the side current-supply conductor is provided with a coagulated droplet of material of the side current-supply conductor. Preferably, the coagulated droplet is made by laser heating of a portion of the side current-supply conductor issuing from the notch. According to the invention, the side current-supply conductor is reliably connected to the lamp base while soldering is dispensed with.

The invention relates to the basing of electric lamps.

In addition, the invention relates to a lamp base for use in an electric lamp.

Electric lamps generally comprise a lamp vessel closed in a gastight manner, the lamp vessel being provided with an illumination source. The illumination source may be, for example, a (tungsten) incandescent body provided in the lamp vessel, which may be a halogen lamp vessel, or a halogen burner provided in the lamp vessel. In addition, the illumination source may be a metal halide lamp provided in the glass vessel.

Electric lamps of the kind mentioned in the opening paragraph are well known in the art. The known electric lamp comprises a central current-supply conductor and a side current-supply conductor, which conductors issue from the lamp vessel. In addition, the electric lamps are provided with a lamp base, also denoted lamp cap. The lamp base normally comprises an externally threaded sheet-metal shell. The lamp base of an electric lamp generally provides a mechanical and electrical connection of the central current-supply conductor and the side current-supply conductor.

The central current-supply conductor and the side current-supply conductor are normally connected to the lamp base by soldering. Soldering is a well-known technology. Commonly employed solder materials are alloys of lead.

A disadvantage of the known electric lamp is that the material used in the soldering process may have toxic aspects. Future regulations may stipulate lead-free soldering.

The invention has for its object to eliminate the above disadvantage wholly or partly. According to the invention, an electric lamp of the kind mentioned in the opening paragraph for this purpose comprises:

a lamp vessel closed in a gastight manner and provided with an illumination source,

a central current-supply conductor and a side current-supply conductor issuing from the lamp vessel,

a lamp base for providing a mechanical connection of the lamp vessel and for providing a mechanical and electrical connection of the central current-supply conductor and the side current-supply conductor,

the lamp base being provided with a notch for passing through the side current-supply conductor at a side facing the lamp vessel,

the side current-supply conductor being provided with a coagulated droplet of material of the side current-supply conductor at a side facing away from the lamp base.

An advantage of the electric lamp according to the invention is that the side current-supply conductor in the notch of the lamp base and the coagulated droplet of material of the side current-supply conductor provide a reliable mechanical and electrical connection to the lamp base. Soldering is thus avoided in the electric lamp according to the invention.

To further enhance the mechanical and electrical contact between the side current-supply conductor and the lamp base, the coagulated droplet is preferably in contact with the lamp base.

Preferably, the coagulated droplet is made by laser heating of a portion of the side current-supply conductor issuing from the notch in the lamp base. The laser melts the side current-supply conductor, and a droplet of molten material travels in the direction of the notch in the lamp base. When the droplet of molten material touches the lamp base at the location of the notch, the heat in the droplet is dissipated in the material of the lamp base. As a consequence, the droplet solidifies at the location of the notch in the lamp base.

Preferably, the side current-supply conductor is made from monel wire. Monel wire is a well-known material used for current-supply conductors in electric lamps. A suitable material for the lamp base is aluminum.

A preferred embodiment of the electric lamp according to the invention is characterized in that the side current-supply conductor is in clamping engagement with the notch in the lamp base. The clamping engagement further enhances the mechanical and electrical contact between the side current-supply conductor and the lamp base.

Preferably, the notch in the lamp base is wedge-shaped. The mechanical and electrical contact between the side current-supply conductor and the lamp base is improved when a wedge-shape notch is used.

Preferably, the notch is provided in the lamp base by means of laser cutting. The shape, in particular the wedge shape of the notch in the lamp base can be provided relatively easily by means of laser cutting.

The invention will now be elucidated in more detail with reference to a number of embodiments and a drawing, in which:

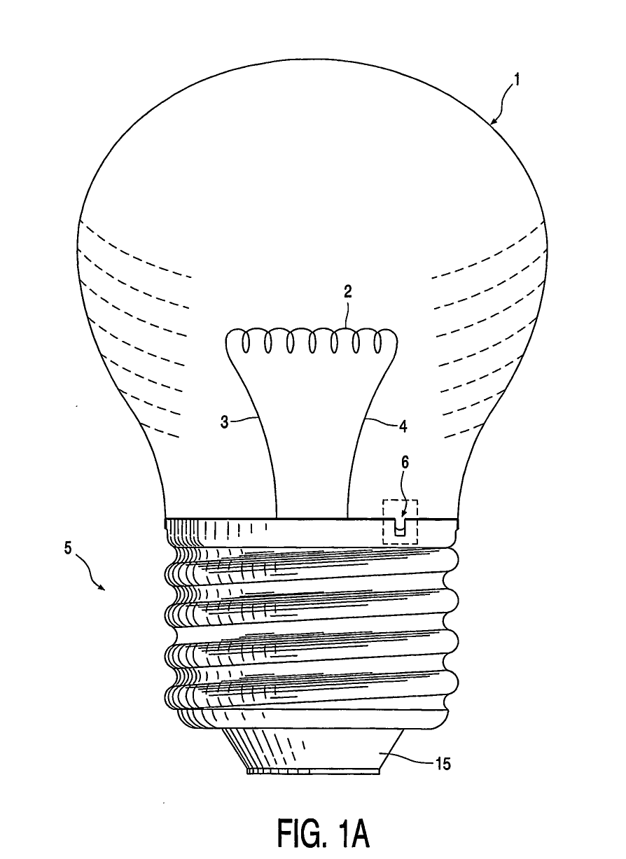

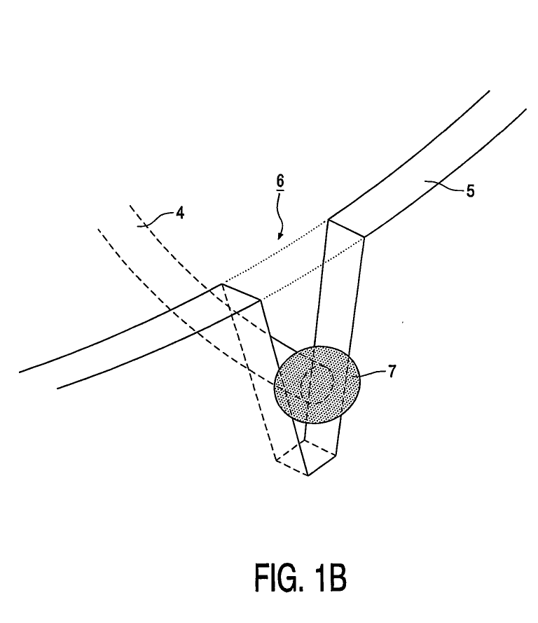

FIG. 1A is a perspective view of an electric lamp according to an embodiment of the invention, and

FIG. 1B is a perspective view of a detail of the lamp base of the electric lamp according to an embodiment of the invention.

The Figures are purely diagrammatic and not drawn true to scale. Some dimensions are particularly strongly exaggerated for reasons of clarity. Equivalent components have been given the same reference numerals as much as possible in the Figures.

FIG. 1A is a schematic, partly perspective view of an electric lamp according to an embodiment of the invention. FIG. 1B is a schematic, partly perspective view of a detail of the lamp base of the electric lamp according to an embodiment of the invention. The electric lamp comprises a lamp vessel 1 closed in a gastight manner and provided with an illumination source 2. In the example of FIG. 1A, the illumination source 2 is a (tungsten) incandescent body. In an alternative embodiment, the illumination source is a halogen burner provided in the lamp vessel. In a further embodiment, the illumination source may be a metal halide lamp provided in the glass vessel.

The illumination source 2 is provided with a central current-supply conductor 3 and a side current-supply conductor 4. The central current-supply conductor 3 and a side current-supply conductor 4 issue from the lamp vessel 1 (not shown in FIG. 1A).

The electric lamp in FIG. 1A is provided with a lamp base 5, also denoted lamp cap. The lamp base normally comprises an externally threaded sheet-metal shell having one end enclosed with a ring 15 of insulation material (for example a glass). The ring 15 is provided with a central aperture communicating with the interior of the shell. Normally the central current-supply conductor 3 is electrically connected to the central aperture in the ring 15.

The electric lamp in FIG. 1A is a typical Edison screw type lamp. The lamp base 5 generally provides the mechanical connection of the lamp vessel 1. In addition, the lamp base 5 provides the mechanical and electrical connection of the central current-supply conductor 3 and the side current-supply conductor 4 to the exterior.

According to the invention, the lamp base 5 is provided, at a side facing the lamp vessel 1, with a notch 6 for passing through the side current-supply conductor 3. In addition, the side current-supply conductor 4 is provided with a coagulated droplet 7 of material of the side current-supply conductor 4 at a side facing away from the lamp base 5. The notch 6 in the lamp base 5 carrying the side current-supply conductor 4 is shown in detail in FIG. 1B. The side current-supply conductor 4 in the notch 6 of the lamp base 5 and the coagulated droplet 7 of material of the side current-supply conductor 4 provide a reliable mechanical and electrical connection to the lamp base. A reliable connection is realized while soldering is dispensed with. To further enhance the mechanical and electrical contact between the side current-supply conductor 4 and the lamp base 5, the coagulated droplet 7 preferably makes contact with the lamp base.

The coagulated droplet 7 is preferably made by laser heating. To this end a portion of the side current-supply conductor 4 issuing from the notch 6 in the lamp base 5 is heated by a laser pulse. The laser melts the side current-supply conductor 4, thus creating a droplet of molten material. The droplet of molten material travels in the direction of the notch in the lamp base. When the droplet of the molten material touches the lamp base 5 at the location of the notch 6, the heat in the droplet is dissipated in the material of the lamp base 5. As a consequence, the droplet solidifies at the location of the notch in the lamp base, thereby forming the coagulated droplet 7.

The side current-supply conductor 4 is preferably made from monel wire. Monel wire is a well-known material used for current-supply conductors in electric lamps. Monel wire comprises 60-70% Ni, 25-35% Cu, 3% Mn, 1% Fe, and 1% Si. A suitable lamp base material is aluminum.

Preferably, the side current-supply conductor 4 is in clamping engagement with the notch 6 in the lamp base 5. The clamping engagement further enhances the mechanical and electrical contact between the side current-supply conductor and the lamp base. The notch 6 in the lamp base 5 as shown in FIG. 1B is wedge-shaped. The side current-supply conductor can be pulled into the notch, for example under the influence of a certain force, thereby enhancing the mechanical and electrical contact between the side current-supply conductor and the lamp base.

The notch 6 is preferably provided in the lamp base 5 by means of laser cutting. The shape, in particular the wedge shape of the notch 6 in the lamp base 5, can be provided relatively easily by means of laser cutting. In addition, the lamp base 5 generally also has a spiral shape in the vicinity of the rim, which makes conventional cutting or sawing rather complicated. Since the material of the lamp base is relatively soft, it is in addition difficult to machine the lamp base without distorting the rim of the lamp base.

The electric lamp according to the invention provides a reliable connection of the side current-supply conductor to the lamp base. Soldering of the side current-supply conductor 4 to the lamp base 5 can be dispensed with.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. An electric lamp comprising:
a lamp vessel (1) closed in a gastight manner and provided with an illumination source (2),
a central current-supply conductor (3) and a side current-supply conductor (4) issuing from the lamp vessel (1),
a lamp base (5) for providing a mechanical connection of the lamp vessel (1) and for providing a mechanical and electrical connection of the central current-supply conductor (3) and the side current-supply conductor (4),
the lamp base (5) being provided with a notch (6) for passing through the side current-supply conductor (3) at a side facing the lamp vessel (1),
the side current-supply conductor (4) being provided with a coagulated droplet (7) of material of the side current-supply conductor (4) at a side facing away from the lamp base (5).

2. An electric lamp as claimed in claim 1, characterized in that the coagulated droplet (7) is in contact with the lamp base (5).

3. An electric lamp as claimed in claim 1, characterized in that the coagulated droplet (7) is made by laser heating of a portion of the side current-supply conductor (4) issuing from the notch (6) in the lamp base (5).

4. An electric lamp as claimed in claim 1, characterized in that the side current-supply conductor (4) is made from monel wire.

5. An electric lamp as claimed in claim 1, characterized in that the lamp base (5) is made of aluminum.

6. An electric lamp as claimed in claim 1, characterized in that the side current-supply conductor (4) is in clamping engagement with the notch (6) in the lamp base (5).

7. An electric lamp as claimed in claim 1, characterized in that the notch (6) in the lamp base (5) is wedge-shaped.

8. An electric lamp as claimed in claim 1, characterized in that the notch (6) is provided in the lamp base (5) by means of laser cutting.

9. A lamp base (5) for use in an electric lamp as claimed in claim 1. N:UserPublic(EAmendmentsNLO30414 prelim.doc 4
